(19) United States
(12) Patent Application Publication
(10) Pub. No.: US 2007/0019499 A1
(43) Pub. Date: Jan. 25, 2007

(54) Front discharge concrete mixer truck

(76) Inventors: Brett Shumaker, Northumberland, PA (US); Allen Thomas, Selinsgrove, PA (US); Craig Beal, Binghamton, NY (US); Matthew Keiser, Orchard Park, NY (US); Robert Vander Decker, Hockessin, DE (US); Steven B. Shooter, Lewisburg, PA (US)

Correspondence Address: Thomas R. Shaffer, 5 East Third Street, Coudersport, PA, 16915, US

(21) Appl. No.: 11/186,168

(22) Filed: Jul. 21, 2005

(51) Int. Cl. B28C 5/42

(52) U.S. Cl. 366/49; 366/50; 366/54; 366/60; 366/68

(57) ABSTRACT

A concrete mixer truck includes a truck chassis having a cab mounted at the front of the chassis. A mixing drum adapted to receive, mix and dispense concrete is mounted at a rear end of the chassis. The drum has a discharge end which faces the cab. A collector is located above the cab roof and is spaced apart from the mixing drum. A conveyor device mounted on a support frame is located generally between the cab and the drum and is utilized to transport concrete from the discharge end of said mixing drum up an inclined slope to the collector. A placement chute system directs a gravity flow of concrete from said collector to a desired location. The mixer truck utilizes the chassis, drum and other components of a standard rear discharge mixer truck to create a new type of front discharge mixer which has many of the advantages of existing front discharge mixer trucks at a reduced cost.

### BACKGROUND OF THE INVENTION

1. Field of the Invention

The present invention relates to a front discharge mixer truck. More specifically, it relates to a mixer truck which preferably utilizes a standard class 8 straight truck chassis and a standard rear discharge mixing drum mounted to discharge forwardly with a conveyor device transporting concrete from the drum to a location over the truck cab for front discharge through a placement chute system.

2. Description of the Prior Art

The concrete production industry uses mixer trucks to transport freshly mixed concrete from a production facility to a job site. There are two types of trucks currently in use by this industry: the rear discharge mixer truck and the front discharge mixer truck. The rear discharge mixer was introduced in the early twentieth century and has undergone few changes since. This truck type composes the majority of the current concrete mixer truck market. A Class 8 straight truck chassis serves as the platform for an assembly of mixer components including a drum, pedestals, chutes and other peripheral equipment. The drum is a large, barrel-shaped container that holds and mixes the concrete components. Pedestals support the drum and the concrete payload inside. The chutes are mounted at the discharge end of the drum and transport concrete from the drum to the ground. The drum and chutes are positioned so that concrete is loaded and unloaded (charged and discharged) at the back of the truck chassis. This allows the chutes to be rotated and elevated without interference from other truck components and maximizes placement range. After charging, the truck is driven to a job site and backed into a pouring location. Concrete discharge is controlled from the back of the truck. After discharge, the truck is driven back to the production plant and washed out to prevent concrete build-up in the drum, on the chutes and on other surfaces. The truck is then recharged and deployed to another job site. At the end of the useful life of the mixer package, one of two options is pursued. The individual mixer components can be replaced or the entire system can be removed from the truck chassis. If the mixer system is removed, the truck can be resold for use in other industries such as mining or logging. Examples of some of the known types of rear discharge mixers are shown and described in Osterlund et. al, U.S. Pat. No. 4,846,581; Mechem, U.S. Pat. No. 4,461,577; and Scratchard, U.S. Pat. No. 5,251,722.

The front discharge mixer was first produced in the 1970's. This mixer incorporates similar components to those used in the rear discharge mixer, but reorients their configuration. The drum and pedestals are rotated so that the discharge end of the drum is directed toward the front of the truck. The drum is lengthened and protrudes over the top of the cab. The chutes are mounted above and in front of the cab and perform the same functions as those on the rear discharge truck. Since the drum extends over the cab, the cab is lowered to provide sufficient space for the drum. This led manufacturers to move the engine to the back of the truck frame rails. Though the cab is lower, the height of the front discharge truck is still 12 inches higher than the rear discharge truck due to the drum extension. More rear axles have also been added to account for an altered weight distribution. To make room for these axles and to accommodate the longer drum, the frame rails of the front discharge truck are typically longer than those of a rear discharge truck. Similarly to the rear discharge machine, worn out mixer components can be replaced. If the concrete producer does not replace the mixer system, the truck has little salvage value. Both mixer truck types are effective at transporting and placing concrete. There are, however, advantages and disadvantages to each truck package. Examples of some of the known types of front discharge mixer trucks are shown and described in Sims, U.S. Pat. No. 4,157,188; Georgoulis, U.S. Pat. No. 6,062,715; Daoust et al, U.S. Pat. No. 4,047,604; Quigley, U.S. Pat. No. 6,149,290; and Blind, U.S. Pat. No. 4,009,868.

Due to its age and coupling with a well-established truck, the rear discharge system is very reliable. The Class 8 straight truck has been built and improved upon by companies like Mack Trucks since the early 1900's. According to owners, there is also a low amount of maintenance required to keep a rear discharge mixer package operational. This means the rear discharge truck is relatively inexpensive to operate and downtime is minimal. The rear discharge truck has a maximum overall height of 146 inches. This height is lower than overpass clearances in both urban and rural areas, allowing the rear discharge mixer to be useful in different markets. Beyond these positive aspects, the rear discharge mixer truck is not without its flaws.

One of the drawbacks of the rear discharge machine is that the driver must back the truck into certain job sites. This requires caution on the part of the driver. Additionally, a worker is needed to direct the truck into place. Once the truck is in position, the driver must exit the truck to control the pour. If the truck needs to be repositioned, the driver must return to the cab and move the truck. This increases time on the job site and thus contractor costs and producer losses.

The front discharge system has several advantages over the rear discharge truck. The main advantage to the front discharge truck is that it can be driven directly into a pouring location. This allows quick and safe positioning by the driver. Since an extra worker is not needed to direct the driver, contractor costs and time on the job site are decreased. Another advantage of the front discharge mixer truck is that while in the cab, the driver can control the pour and have a clear view of chute position. This allows quicker chute positioning and subsequent truck movements during a longer pour. Safety is also improved since the driver does not leave the cab. Current front discharge mixer trucks are equipped with standard all-wheel drive and off-road tires. This permits the front discharge truck to have greater and easier access to difficult locations. Contractors benefit from this aspect because it reduces the need to build access roads to job sites. Though the front discharge mixer has a large advantage in pouring from the front and has other positive qualities, it is fraught with disadvantages.

The front discharge concrete mixer truck is more expensive than the rear discharge truck. The truck is custom built by each manufacturer and has a unique drive train and engine position. This chassis package is specifically designed for concrete delivery and does not lend itself to other applications. Increased customization leads to frequent, difficult and expensive maintenance as well as higher manufacturing costs and low salvage value. According to market feedback, rear discharge mixer components are replaced about every fifteen years. Front discharge truck components, including mixer package components and chassis parts, commonly wear out in about six to ten years. It is common for concrete producers to replace all major truck and mixer package components and reuse only the cab, axles and engine. This is an enormous and frequent expense. Beyond financial drawbacks, the front discharge mixer has several functional problems. Front discharge machines have an awkward weight distribution. The majority of the concrete load is carried by the rear pedestal located toward the back of the truck. The engine is also mounted at the very back of the truck and provides more weight to the rear. In order to comply with federal and state weight laws, several axle configurations are required. The longer frame rails of the front discharge package experience more twisting during use and the front discharge truck chassis wears out much more frequently than that of the rear discharge truck. Another major problem is that front discharge machines have difficulty pouring low slump concrete or concrete with little water in it. Low slump concrete has a tendency to cling to the drum walls and internal mixing blades, decreasing concrete flow rate. Furthermore, the concrete must travel a longer distance through a steadily narrowing drum and flow rate is reduced even more. Since the front discharge truck is 12 inches higher than rear discharge mixers, the front discharge system is limited to rural markets where overpasses will allow a 158 inch high truck to pass through. A higher truck increases the probability of impacting an overpass and can lead to safety and financial concerns.

Concrete producers and contractors have differing opinions regarding each mixer type. Once a producer has delivered concrete in a front discharge machine, contractors then wish to have concrete delivered only from a front discharging truck due to the time and cost savings involved. The contractor grows to dislike the rear discharge mixer. Concrete producers, on the other hand, bear the burden of providing a more expensive delivery system for the contractor in order to satisfy them and keep their business. This leads to concrete producers investing tremendous amounts of money into a flawed system.

A variety of prior art patents exist which relate to virtually every aspect of the design and operation of a mixer truck. For example, Alton, U.S. Pat. No. 5,492,402, discloses a mixer drum mounted onto a self propelled trailer. Strehlow, U.S. Pat. No. 4,951,261, and Braun, U.S. Pat. No. 5,820,258, disclose drum supports. Yelton, U.S. Pat. No. 5,207,551; Oury et al., U.S. Pat. No. 4,624,357; and Oury, 3,945,484 disclose various conveyor devices for moving concrete. Cain, U.S. Pat. No. 6,350,051, discloses a hopper assembly for a cement truck. Finally, Bonnette, U.S. Pat. No. 6,041,907; Silbernagel, U.S. Pat. No. 5,192,178; Christenson, U.S. Pat. No. 5,184,706; and Lybbert, U.S. Pat. No. 4,190,144, each disclose one of various known chute systems for concrete trucks and the like.

### SUMMARY OF THE INVENTION

In its simplest form, the concrete mixer truck of the present invention comprises: a) a truck chassis; b) a cab mounted at the front of said chassis, said cab having an upper surface; c) a mixing drum adapted to receive, mix and dispense concrete, said drum mounted on pedestals at a rear end of said chassis, said drum having a discharge end facing said cab with the point of discharge located below said upper surface; d) a collector located above and in front of said upper surface of said cab and spaced apart from said mixing drum; e) conveyor means located generally between said cab and said drum, said conveyor means adapted to transport concrete from said discharge end of said mixing drum to said collector; and f) a placement chute system adapted to direct a gravity flow of concrete from said collector to a desired location.

Preferably, said truck chassis is a straight class 8 truck chassis and has a mixing drum which is a drum of the type utilized on rear discharge mixer trucks but wherein said drum is rotated 180 degrees from such typical rear discharge orientation.

The mixer truck preferably has a rear pedestal and a front pedestal each mounted to said chassis to support said mixing drum and allow rotation of said mixing drum with said front pedestal including a pair of vertical support members which are generally triangular in shape.

The conveyor means preferably further comprises a support frame to support a conveyor device along a desired inclined orientation with said support frame allowing the conveying device to be moved into and supported in a pouring position by a hydraulic cylinder when in operation and in a driving position when not in operation with said driving position being lower than said pouring position thereby allowing the concrete mixer truck to have a lower overall height when being driven than when pouring concrete. The conveying means preferably includes a slider mechanism assembly positioned between a conveying device and said support frame to allow for sliding movement of said conveying device back and forth between said pouring position and said driving position.

The conveyor means preferably includes a conveyor device in the form of a belt conveyor but alternatively may have a conveyor device in the form of an auger or screw conveyor.

The placement chute system preferably further comprises a first chute, a second chute and a third chute where said first chute is mounted at one end thereof to a mounting ring and linkage members to allow said first chute to be moved rotationally about said first end and to allow a forwardly extending second end to be moved upwardly and downwardly by means of a pair of hydraulic cylinders. The linkage members preferably include two pairs of straight members, a pair of generally triangular shaped members, an arch-shaped chute lifting bar and a large plate that is generally rectangular in shape wherein the plate is attached to the outer diameter of said mounting ring, a first corner of each triangular shaped linkage member is attached to a pair of straight members, a second corner of each triangular shaped linkage member is attached to a central ear provided on said plate and a third corner of each triangular member is attached to one end of a hydraulic cylinder with an opposite end of each hydraulic cylinder attached to a back ear mounted rearwardly of a rear end of said plate. Each pair of said straight members is also attached to ears on opposite ends of said arch-shaped chute lifting bar. Preferably, said second chute is mounted to and folds upwardly onto said first chute and said third chute is mounted to and folds upwardly onto said second chute.

Preferably, the concrete mixer truck further includes a control system for controlling the operation of at least one of the following operations, namely, rotation of the mixing drum, discharge of the mixing drum, movement of a conveyor device from a driving position to a pouring position, operation of a conveying device and movement of the placement chute system to a desired location. Preferably, said control system includes a control panel located inside said cab for operation by an operator of the truck without leaving the cab.

The rationale for designing a new type of concrete mixer truck system is clear. The positive aspects of both machines are to be integrated into one system. The goal is to design a truck that will have better functionality, lower cost and higher salvage value than current front discharge mixer trucks. A rear discharge truck chassis and mixer components will be used in this new design. The drum will be turned to discharge toward the front of the truck in a manner similar to that of the front discharge truck. However the drum will not be lengthened. Chutes will be mounted above and in front of the truck cab and direct concrete to the ground in front of the truck. A conveying system will be used to transport the concrete from the discharge end of the drum to the chutes. In order to support this system, a steel structure will be built on the truck frame rails. By using the rear discharge style components and truck chassis, the proposed design will be less expensive to produce than current front discharge systems. It will also increase salvage value and reliability. The rear discharge style drum will have a larger discharge opening than the front discharge style drums and allow a faster concrete flow rate. The mixer will discharge from the front of the truck at an initial point that is higher than the current front discharge systems, providing a steeper maximum chute inclination angle. The new design will also have a maximum height of 146 inches and therefore be marketable to urban areas. The use of a front discharge style chute system will provide adequate reach and angular range to be comparable with current front discharge mixers. Furthermore, the pour will be controlled from within the truck cab. This will improve pour efficiency and accuracy as the driver will be able to see the pour from the driver's seat. Though the proposed design provides solutions to many problems faced by front discharge machines, it is not free from disadvantages.

One disadvantage to this design is that loading and wash out will occur in the middle of the truck as opposed to one of the ends. This may limit the use of the mixer at plants where obstructions interfere with driving the truck completely underneath the charging duct. During washout, excess concrete is discharged from the drum and the drum is filled with water to wash away and remove unwanted concrete buildup. Additionally, other mixer components are washed off to prevent hardening of excess concrete. As the drum discharges the excess water and concrete, it is usually carried directly down the chutes. The drum on the proposed design will discharge concrete onto a conveyor which will then need to be operating to send the washout material to the chutes. Otherwise the conveyor will need to remove the material differently. The cab of the Class 8 truck that will be used for this design sits higher than current front discharge truck cabs. If pouring is performed directly in front of the truck, the driver may have difficulty seeing the end of the chutes. This could affect pour efficiency and accuracy. The cab also introduces limitations on chute placement. Current concrete mixer truck chutes are mounted at the end of the truck. This allows unrestricted angular ranges and inclination angles. The chutes on the proposed design will need to be spatially limited in order to prevent impact with the cab. By incorporating a conveyor and support structure, more weight is added to the overall system. Federal regulations limit the maximum weight of any Class 8 truck to 80,000 pounds. Since concrete is very heavy, adding more weight could require a decrease in mixer payload. This is highly undesirable as it will affect concrete producer profits.

Overall, the opportunity to provide the concrete industry with a new product is good. The many advantages of the proposed design outweigh its disadvantages.

The present invention provides a modification of a rear discharge concrete mixer truck to allow for discharge from the front of the mixer. The design requires the use of a Class 8 straight truck and must discharge its concrete at a rate competitive to existing concrete mixer trucks. Also, the redesign must be capable of discharging any slump type. The properties of concrete poured at one job site may be different than at another, therefore the design must be capable of handling all variants of concrete. In addition, the design must be capable of discharging concrete 30 feet in front of the driver in a 180 degree range. Like current front discharge trucks, the truck driver should have full control over the chute system from within the cab without visual obstructions. The present invention preferably should utilize standard rear discharge mixer components including: the drum, chutes, pedestals and peripheral equipment. Changes made to these common components increase production time and the cost of the design. Preferably, no alterations should be made to the cab in order to allow the design to work with various cab shapes and sizes.

From an industry perspective, it is important for the redesigned truck to cost less than any competing front discharge truck. Additionally, the truck must be useful as a flat bed or dump truck upon reaching the end of its life cycle in order to increase its salvage value. Since many front discharge trucks are not able to place concrete in urban areas due to low overpasses, it is important for the redesigned truck to be capable of maneuvering under any of these obstructions. Furthermore, the mixer package should fit all class 8 straight trucks and preferably have a mixer life of at least 15 years.

The present invention requires a novel approach to the transportation and distribution of concrete to the pouring location. In order to further describe the design, the truck package is divided into three main subsystems. These subsystems perform separate functions and are independent of each other except at their interfaces. The subsystems include transport and mixing, collection and elevation and distribution and placement.

The purpose of the transport and mixing subsystem is to hold the concrete during transportation while mixing its contents to achieve the proper slump at delivery. This subsystem is also responsible for discharging the concrete from the drum when desired. Components of the transport and mixing subsystem include: the front pedestal, the rear pedestal, the drum, the control system and other miscellaneous mixer package components (i.e. the water tank, hydraulic pump, etc.).

The purpose of the collection and elevation system is to gather the discharged concrete from the drum and transport it to distribution and placement subsystems. Components of this subsystem include: a collector, an elevator, a support structure, a system for stowing the elevator and a control system. This subsystem is not known in the art in either front or rear discharge mixer trucks.

The distribution and placement subsystem receives concrete from the collection and elevation subsystem and delivers it to a location specified by the driver. This location is controlled by the direction and elevation of the chutes as well as the truck placement. The primary components for this subsystem include: the collector, two degrees of freedom chute joint, primary chutes, support and control system.

The role of the elevation subsystem is to collect the concrete discharged from the drum and transport it to a location above the cab of the truck. One conveying device method considered is the use of an auger. The auger, rotating inside a tube, causes the concrete to ride upward along the tube due to the relative motion of the auger blades. The presently preferred conveying device method utilizes a belt conveyor to move the concrete from the drum discharge to the over-cab location of the chute system. The conveyor, using a ribbed belt and a concave track, moves the concrete to the over-cab location just as a conventional conveyor, differing only in the fact that this conveyor must move both the liquid and solid components of the concrete.

A variable height system is preferably provided for the conveying device. In this setup, the conveying device is stowed partially beneath the mixer drum, giving a lower total truck height profile. In a mixer truck package where height is already a concern due to low overpass clearance, limiting total truck height is an important consideration and can be a selling point for the package.

In order to place the concrete in the desired location, a chute subsystem is required. This subsystem consists of the first, second and third chutes and their supports. Upon exit of the transportation subsystem, the concrete has been elevated to a height between eleven and fourteen feet above the ground. The chute system, therefore, must accept concrete at an elevated location and use the force of gravity to place the concrete into position.

One consideration in the design of the present invention is the gross vehicle weight. Each state has different weight regulations that must be followed in order for a truck to travel on its roads and highways. These weight restrictions vary, but generally define specific amounts of weight that can be carried on each axle of a truck. Since concrete weighs approximately 4000 lbs per cubic yard, a filled drum is approximately 45000 lbs, or over half of the gross vehicle weight limit, the truck chassis and mixer component weight is an important consideration. The concrete producers wish to carry as much concrete as possible while remaining under the legal load limit. Thus, the components added to the present invention are preferably relatively lightweight and are distributed properly so that the weight per axle rules are obeyed.

The other considerations for the entire truck are the height, width and length requirements. A class 8 straight truck is allowed a maximum length of forty feet, a maximum width of eight feet and twelve feet two inches is presently preferred as the maximum height.

The transport and mixing subsystem was perhaps the least affected by the design of the present invention for the concrete mixer. Much of this subsystem remained unchanged. After rotating the drum 180 degrees, the former front pedestal became the new rear pedestal. However, this new rear pedestal required no modifications, nor did the gearbox or mixing drum. This simplified the design greatly. The accessory mixer components necessary for this system, such as the hydraulic pump, controls, hoses and others were also kept in their original form, though they will be relocated after the major components are completely placed so that they do not cause a weight distribution problem or interfere with other necessary components.

The major change to the transport and mixing subsystem in the present invention is the new front pedestal. This new front pedestal was redesigned while attempting to preserve as much of the existing rear discharge rear pedestal geometry as possible. The only parts of the new front pedestal that needed to be changed were those parts below the rollers that support the drum. The reason for this was that the support frame for the conveyor, collector and chute systems needed to extend beneath the front part of the drum. Since the pedestal was already occupying the space, the two separate supports were integrated into one unified support.

Three pieces of square tubing (2″×4″×¼″ thick) welded together with a plate on the outside form the vertical triangular shaped supports that fit to the frame below them. These are joined together by the top plate that supports the rollers and a pair of steel gusset plates, cut and welded to the front and back of the verticals, to provide resistance against lateral forces. Finally, an additional pair of angled square-tubing pieces serves as support for the ends of the top plate.

The collection and elevation subsystem is far more complicated than the transport and mixing subsystem and is the primary difference between conventional mixers and the design of the present invention. As defined previously, this subsystem is responsible for collecting the concrete from the drum discharge, elevating it over the cab and passing the concrete on to the distribution and placement subsystem.

The motivation for using the discharge spout (not shown) is that the concrete that comes out of the drum does not necessarily leave the drum in a smooth or consistent manner. The concrete can surge and splash or come out slowly. The conveyor also must receive the concrete in the proper location so that the concrete is entrained in the fins of the conveyor and taken along its length. Thus, it is important to have the spout channel the concrete in a proper path from the drum to the conveyor.

This spout will have a configuration which closely follows the design of the current rear discharge spout which places the concrete directly into the chutes. The shape is preferably customized to ensure that concrete is effectively collected and placed onto the conveyor in the best manner to keep the concrete moving smoothly.

The elevation of the concrete by the conveying means to a location above the cab is perhaps one of the most unique portions of the present invention design. A conveyor having a belt width of 24″, total width of 28″ including gearing, flow rate of 6 cubic yards per minute and total conveyor height of approximately 14″ is preferred.

The frame for the conveyor means, chute system and collector is preferably in the form of a truss structure, with all of the beams being either pulled in tension or pushed in compression. In order to integrate the conveyor into the frame, space was left on the inside of the frame to allow for the conveyor movement. The frame requires attachment to the truck rails only behind the cab. This may be accomplished by using large diameter bolts or preferably with dynamic mounts to reduce vibration and torsion transmitted to the rails of the truck. The frame and beam elements are preferably formed with pieces of square tubing cut and assembled to produce the desired geometry.

The height restriction desired for the present invention resulted in the incorporation of an actuation system for the conveyor to allow the driving height of the truck to be lower than its pouring height. This actuation system consists of hydraulic cylinders, mounts, sliders, and a sliding platform integrated into the frame. Sliders are provided on the conveyor to allow for actuation to occur. Each slider assembly consists of nylon material attached to angle iron which is welded to the conveyor. The sliders then rest on said sliding platform which is attached to the support frame.

To direct the altered conveyor, two pairs of steel angles are attached to the inside of the support frame with one pair being welded and the other pair being bolted. These angles are mounted to allow a slight gap between the slider and the top angle to allow for smooth sliding on either the top or bottom surface of the channel.

These sliders are necessary for two reasons. First, the hydraulic cylinder cannot be misaligned with the conveyor motions. Secondly, a misaligned conveyor could cause friction and excessive wear to the sliders.

One hydraulic cylinder produces enough force to raise and lower the conveyor while loaded.

The control system for the collection and elevation subsystem consists of two parts. The first is control of the conveyor actuation. For the driver, this should be a 2-position switch, giving only the option of up or down. This could be accomplished by using limit switches to control the range of the hydraulic cylinder actuation. Another important consideration is safety for this subsystem. The switch or control should be protected so that the driver cannot accidentally actuate the conveyor. The worst case scenario for the conveyor is for the driver to unintentionally raise the conveyor to the “up” position and then drive under a low overpass, causing the conveyor to strike the overpass.

The second portion of these controls is for the conveyor motion. The conveyor speed will need to be regulated for concrete delivery. The current control system controls conveyor belt speed by adjusting the flow rate of hydraulic oil to the motor. This is accomplished via a rotary knob.

The primary function of any mixer truck is to deliver concrete to a specified location. Over the years, these trucks have been outfitted with increasingly complicated systems of chutes and actuation, allowing the driver to have better control over the delivery of the concrete. Existing current front discharge mixer trucks allow the driver to elevate and rotate the chutes from within the cab, along with being able to reposition the truck as necessary. The present invention also has this same ability.

The conveyor transports the concrete above the cab, where it is collected and directed into the chute system for delivery. The concrete collector provides this redirection. As the concrete drops from the conveyor, it enters the square cross-sectional opening of the collector, positioned directly below the conveyor exit. This cross-section then transforms into a circular cross-section which allows the chute support ring to fit around the base of the collector. The concrete then flows directly through the collector and onto the chutes below.

The design for this collector is unique and allows for the chute ring to hang off from it while still having a large opening for the concrete. The cuts on both of the cylindrical part and the flat faces are complex, but can be made using a CNC cutting machine on a flat piece of plate and then rolled and/or welded into place. The plate is reinforced by a tube steel frame which cradles both the angled sides and cylindrical tube of the collector.

The present invention provides an innovative solution to the chute actuation system. To place concrete in the desired locations, the chutes must be capable of rotating about the vertical axis of the support ring and also about the main chute hinges. The chute system is supported from the collector by a custom support ring designed to fit the pre-existing front discharge chute race which when fitted with a rolled plate steel extension forms the mounting ring mentioned in paragraph 15. The new support ring is welded to the underside of the collector and is formed by rolling two pieces of plate steel and welding them together. From this support ring, the mounting ring is hung with the chutes and actuation system attached.

The front discharge chute race contains a thrust bearing which allows the chutes to rotate freely around the vertical axis. The setup allows the chutes to rotate 180° about the collector. Thus, the rotational axis has the proper range of motion.

The second degree of freedom necessary is the elevation of the chutes. On current front discharge mixer trucks, the elevation of the chutes is accomplished through the use of hydraulic actuators fixed to a bracket on the front bumper of the truck. Since the present invention is intended to be independent of the truck chassis chosen, the option of using the front bumper for support is unavailable. The actuation, therefore, must rotate with the chutes. This requires the equipment for the elevation of the chutes to be attached to the rotation ring. However, this creates a problem in that space constraints require the hydraulic cylinders to be placed in a downward orientation. This drives the design to incorporate a four-bar linkage to redirect the force into useful upward force on the chutes. To balance the forces, identical linkages are placed on both sides of the chutes. The components of the linkage system are described in the following paragraphs.

A pair of hydraulic cylinder is used to produce the force input for the chute elevation. It is preferred that each actuator must provide a minimum of 30,000 pounds of force. The maximum space available for the actuator in its closed position is 24 inches and the required stroke is 16 inches. Using these three values, hydraulic cylinders can be specified to drive the chute elevation system.

The base of the linkage, counting as the first bar in the four-bar linkage, is the plate found in the placement chute system. This plate carries large pins. These pins will be used to attach the remaining links in the elevation mechanism.

A second bar in the linkage is the main chute itself. The main chute is connected by hinges to the chute race which is attached to the plate, as is already done on front discharge mixers. However, in order to accommodate the actuation, there is an added piece on the main chute that matches the contour of the bottom of the chute and is welded on to connect to the linkage. The double opening is necessary to connect to the remainder of the linkage system.

The third piece of the linkage is composed of a pair of bars that extend upward from the main chute. These bars are connected by a pin to the main chute support. The reason for the doubling of the bars is to reduce the stresses in each bar, as well as allowing for a symmetrical loading on the rest of the bars and pins in the linkage.

The last link of the elevation mechanism is triangular and is shale with a hole at each corner.

The primary chutes for the present invention mixer design were kept as close to the stock front discharge design as possible to help reduce the manufacturing cost of the truck. The major difference is in the length of the main chute.

The support for the whole collector and chute assembly comes from the support frame. The collector is welded to the support frame, which is attached to the frame rails behind the cab. In this manner, the chutes are secured to the truck.

It is contemplated that an automatic washout system could be integrated into the chute and elevation systems which would be capable of speeding up the washout process, thus reducing the total downtime between each pour. It is also contemplated placing lights on the truck could be utilized to illuminate the pour location. This would aid the drivers in seeing the concrete as it leaves the chute. Also, since the present invention is capable of utilizing a standard truck cab and concrete being poured directly to the front of the truck would be hidden below the hood, it is also contemplated that a well-placed mirror would provide the driver with sufficient visibility at the end of the chute to help control the pour. This mirror or set of mirrors could be added either to the truck cab or to the chute system.

These and other objects and features of the present invention will be more fully understood upon reference to the following drawings and descriptions.

### BRIEF DESCRIPTION OF THE DRAWINGS

FIG. 1 is a perspective view of a concrete mixing truck according to the present invention.

FIG. 2 is a perspective view of a front pedestal member to support the discharge end of the drum of the present invention.

FIG. 3 is a perspective view of a conveyor means in the form of a belt conveyor.

FIG. 4 is a perspective view of a support frame for the conveyor means and the collector and chute system of the present invention.

FIG. 5 is a perspective view of the placement chute system of the present invention.

FIG. 6 is a side elevational view showing the collector ring and linkage mechanism by which the chute system is connected to the collector.

FIG. 7 is a perspective view of the ring of the collector.

FIG. 8 is a perspective view of a conveyor means in the form of an auger or screw type conveyor as mounted on chassis.

### DETAILED DESCRIPTION OF THE PREFERRED EMBODIMENT

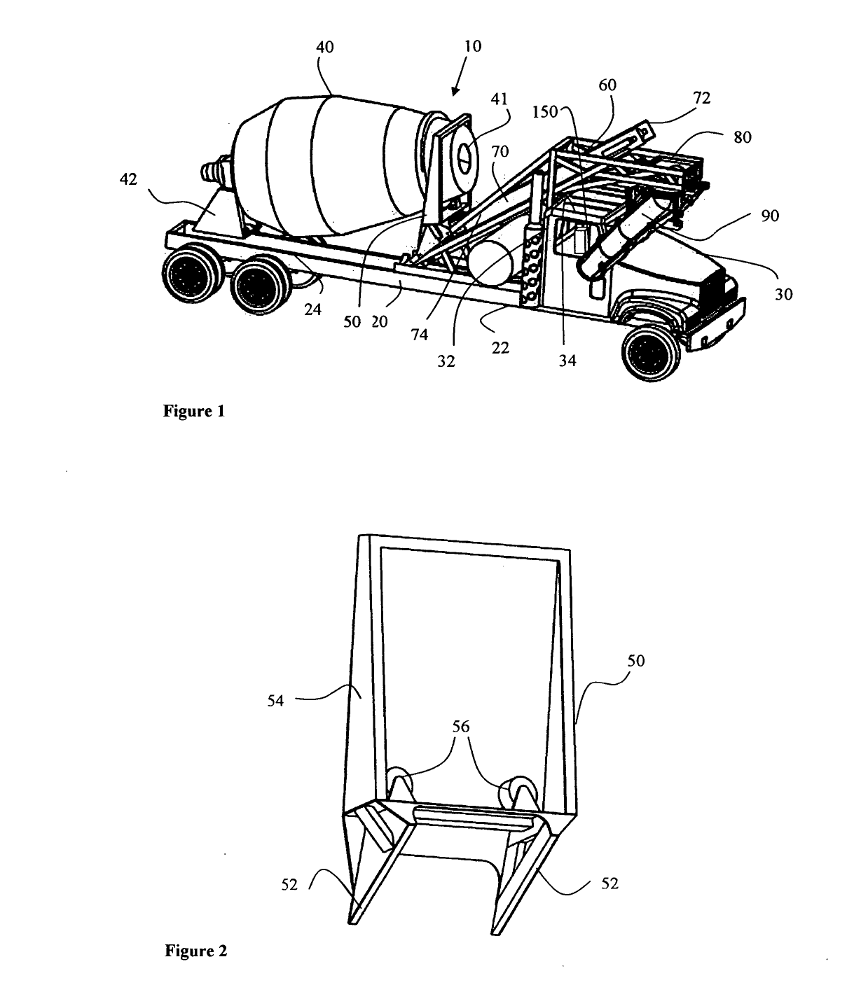

Referring to FIG. 1, a new type of front discharge concrete mixer truck 10 is shown. Mixer truck 10 includes a chassis 20 which has a forward end 22 and a rear end 24. A cab 30 is mounted on the forward end 22 of the chassis 20 and a mixer drum 40 is attached to the rear end 24 of the chassis 20. The mixer drum 40 is a standard drum of the type typically utilized on rear discharge mixer trucks. The drum, however, is rotated 180° so that the discharge end of the drum 41 faces the back 32 of the cab 30.

The cab also has a roof 32 which defines an uppermost surface of the cab and a control panel 150 is mounted inside the cab to control the various operations which the mixer truck provides.

The mixer drum 40 is attached to the chassis 20 but by means of a rear pedestal 42 (which has a configuration identical to a typical front pedestal of a typical rear discharge mixer truck) and is attached at the front end by means of a front pedestal 50.

A support frame 60 is provided in the space between the cab 30 and the discharge end 41 of the mixer drum 40 for the purpose of supporting a conveying means 70 and collector 80. It is noted that a discharge end 72 of the conveyor 70 and the collector 80 are each located above the upper surface defined by the roof 34 of the cab 30.

As will be described in greater detail below, the conveyor 70 is adapted to slide between a pouring position and a driving position. When in the driving position, the discharge end 72 is located at a height equal to or below the height of the collector 80. In the driving position, the charging end 74 of the conveyor is slid substantially underneath the discharge end 41 of drum 40. In the pouring position, the entire conveyor 70 is moved upwardly so that the discharge end 72 of the conveyor 70 is located directly above the collector 80. The charging end 74 of the conveyor is located directly below the discharge end 41 of the drum 40. A discharge spout (not shown) similar to collector 80 is provided as the interface between the charging end 74 of the conveyor and the discharge end 41 of the drum 40.

Once concrete is transported by the conveying means into the collector 80, it passes through the collector to a placement chute system 90.

Referring to FIG. 2, the details of the construction of the front pedestal member are shown. The pedestal member 50 includes a pair of triangular vertical support members 52, an upper arch 54 and has a pair of rollers 56 which facilitate the rotational movement of the mixer drum 40.

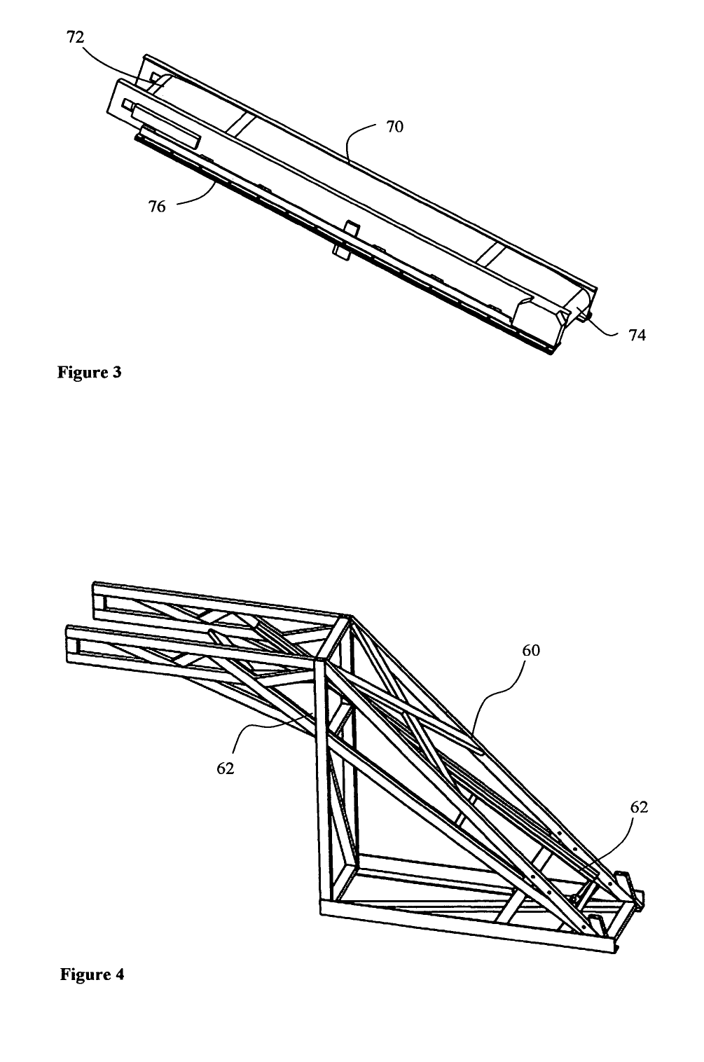

Referring to FIG. 3, the details of the presently preferred conveyor 70 of the present invention are shown. The conveyor 70 has a charging end 74, a discharge end 72 and has a slider assembly 76 located on each side of the conveyor 70. These rollers 76 facilitate the entire conveyor device 70 sliding upwardly or downwardly on rail portions 62 of the support frame 60 as shown in FIG. 4. The conveyor 70 is mounted with a subassembly of structural steel on its underside which allows the attachment of a hydraulic cylinder to provide the force needed to move the conveyor 70 upwardly or downwardly on said rails 62 between an upper pouring position and a lower driving position and the force to hold the conveyor in either of said positions.

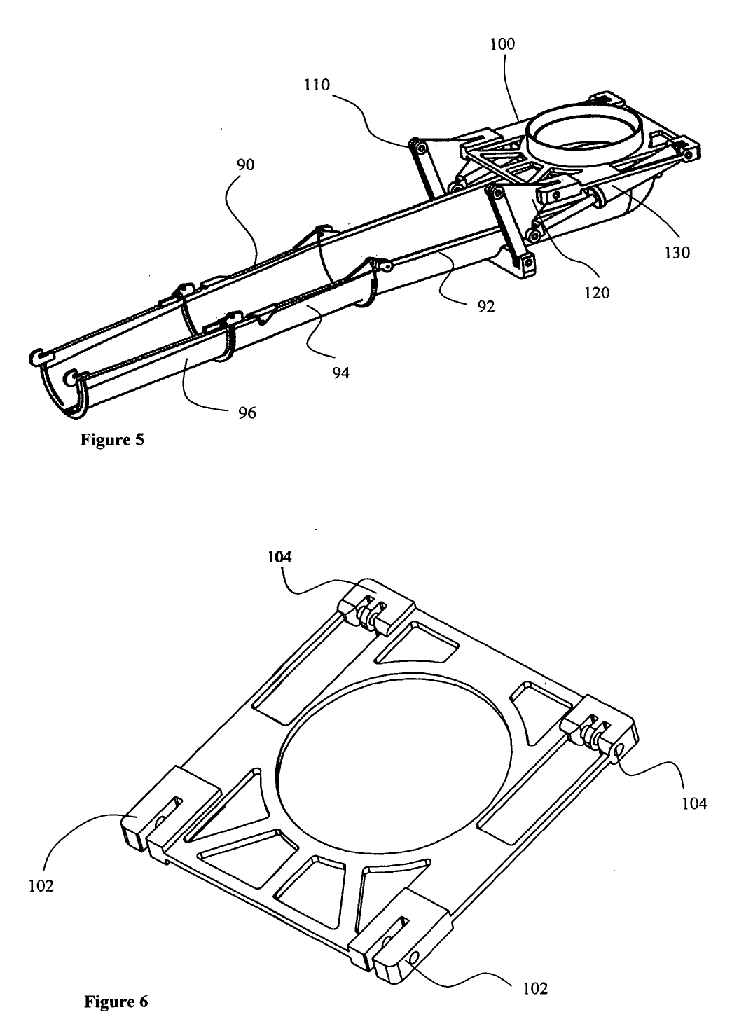

Referring to FIG. 5, the details of the presently preferred placement chute system is shown. The system includes the chute race and plate subassembly 100 to which a first chute 92 is attached by a linkage mechanism which will be further described below. A second chute member 94 is pivotally connected to the lower end of chute 92 and a third chute member 96 is pivotally connected to the lower end of chute 94.

The chute system 90 provides for both rotational movement and for elevational movement providing the ability to place concrete at any desired location on the ground within approximately 180°, the center of which being at the front of the cab.

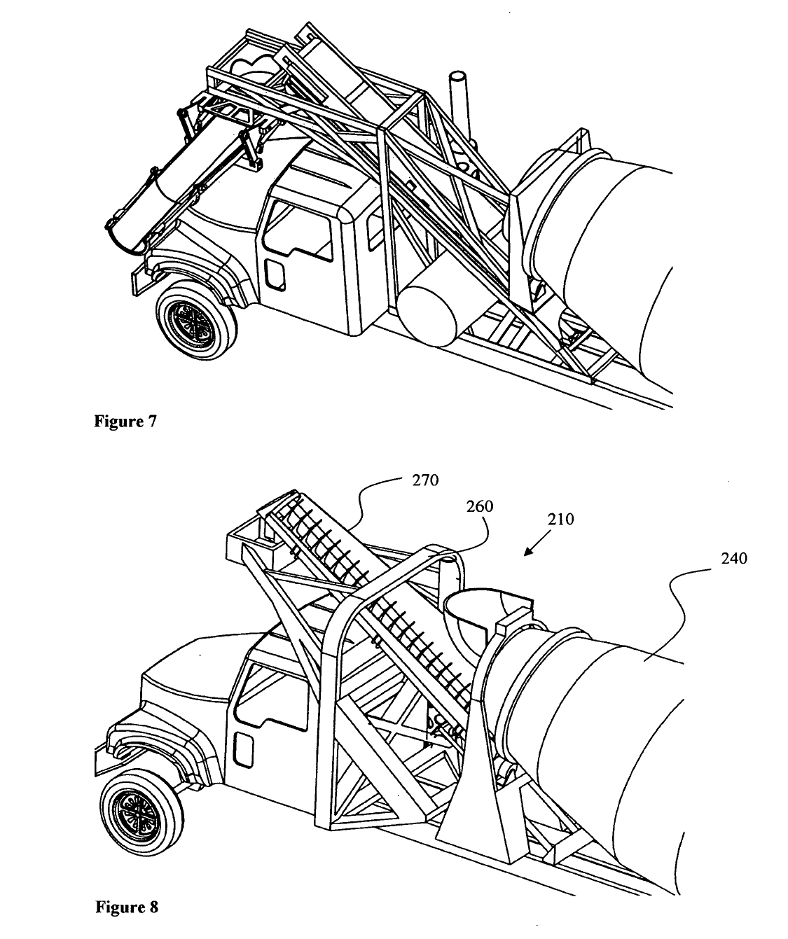

The details of the linkage mechanism and the plate are shown respectively in FIG. 5 and FIG. 6. The chute race and plate subassembly 100 has a generally triangular linkage member 120 attached to ears 102. The triangular member 120 also has a hydraulic cylinder 30 which connects both to the triangular member 120 as well as to ears 104 located rearwardly on the plate. Bar members 100 are connected between the triangular member 120 and the first chute 92. As can be seen from FIG. 7, an identical arrangement is provided on both sides of the plate.

FIG. 7 shows a closer view of the present invention.

FIG. 8 shows a modified version of the present invention wherein a front discharge mixer truck 210 having a drum 240 has a conveyor means 270 in the form of an auger or screw conveyor attached by means of a frame 260.

The invention having been disclosed in connection with the foregoing variations and examples, additional variations will now be apparent to persons skilled in the art. The invention is not intended to be limited to the variations specifically mentioned, and accordingly, reference should be made to the appended claims rather than the foregoing discussion of preferred examples, to assess the scope of the invention in which exclusive rights are claimed.

I claim:

1. A concrete mixer truck comprising:
a) a truck chassis;
b) a cab mounted at a front of said chassis, said cab having an upper surface;
c) a mixing drum adapted to receive, mix and dispense concrete, said drum mounted at a rear end of said chassis, said drum having a discharge end located below said upper surface and facing said cab;
d) a collector located above said upper surface of said cab and spaced apart from said mixing drum;
e) conveyor means located generally between said cab and said drum, said conveyor means adapted to transport concrete from said discharge end of said mixing drum to said collector; and
f) a placement chute system adapted to direct a gravity flow of concrete from said collector to a desired location.

2. A concrete mixer truck according to claim 1 wherein said truck chassis is a straight class 8 truck chassis.

3. A concrete mixer truck according to claim 1 wherein said mixing drum is a drum of the type utilized on rear discharge mixer trucks but wherein said drum is rotated 180 degrees from such typical rear discharge orientation.

4. A concrete mixer truck according to claim 1 further comprising a rear pedestal and a front pedestal each mounted to said chassis to support said mixing drum and allow rotation of said mixing drum.

5. A concrete mixer truck according to claim 4 wherein said front pedestal includes a pair of vertical support members which are generally triangular in shape.

6. A concrete mixer truck according to claim 1 wherein said conveyor means further comprises a support frame to support a conveyor device along a desired inclined orientation.

7. A concrete mixer truck according to claim 6 wherein said support frame allows the conveying device to be supported in pouring position when in operation and in a driving position when not in operation with said driving position being lower than said pouring position thereby allowing the concrete mixer truck to have a lower overall height when being driven than when pouring concrete.

8. A concrete mixer-according to claim 7 wherein said conveying means includes a slider assembly positioned between a conveying device and said support frame to allow for sliding movement of said conveying device back and forth between said pouring position and said driving position.

9. A concrete mixer according to claim 7 wherein said conveying means further comprises a hydraulic cylinder actuator positioned between said conveying device and said support frame to move a conveying device back and forth between said driving position and said pouring position.

10. A concrete mixer truck according to claim 1 wherein said conveyor means includes a conveyor device in the form of a belt conveyor.

11. A concrete mixer truck according to claim 1 wherein said conveyor means includes a conveyor device in the form of an auger or screw conveyor.

12. A concrete mixer truck according to claim 1 wherein said placement chute system further comprises a first chute, a second chute and a third chute.

13. A concrete mixer truck according to claim 12 wherein said first chute is mounted at one end thereof to a mounting ring and linkage members to allow said first chute to be moved rotationally about said first end and to allow a forwardly extending second end to be moved upwardly and downwardly.

14. A concrete mixer truck according to claim 13 wherein said first chute is moved by a pair of hydraulic cylinders.

15. A concrete mixer truck according to claim 14 wherein said linkage members include a pair of arch shaped members and a pair of generally triangular shaped members.

16. A concrete mixer truck according to claim 15 wherein a first corner of each triangular shaped linkage member is attached to an arch member, a second corner of each triangular shaped linkage member is attached to a frontward ear provided on opposite sides of said plate and a third corner of each triangular member is attached to one end of a hydraulic cylinder with an opposite end of each hydraulic cylinder attached to a back ear mounted at rearwardly of a rear end of said plate.

17. A concrete mixer truck according to claim 12 wherein said second chute is mounted to and folds upwardly onto said first chute.

18. A concrete mixer truck according to claim 12 wherein said third chute is mounted to and folds upwardly onto said second chute.

19. A concrete mixer truck according to claim 1 further comprising a control system for controlling the operation of at least one of the following operations, namely, rotation of the mixing drum, discharge of the mixing drum, movement of a conveyor device from a driving position to a pouring position, operation of a conveying device and deployment and movement of the placement chute system to a desired location.

20. A concrete mixer truck according to claim 19 wherein said control system includes a control panel located inside said cab for operation by an operator of the truck without leaving the cab.
